(19) United States
(12) Patent Application Publication
(10) Pub. No.: US 2005/0010687 A1
(43) Pub. Date: Jan. 13, 2005

(54) Multiprocessor network multicasting and gathering

(75) Inventor: Donglai Dai, Eau Claire, WI (US)

Correspondence Address: Schwegman, Lundberg, Woessner & Kluth, P.A., P.O. Box 2938, Minneapolis, MN, 55402, US

(73) Assignee: Silicon Graphics, Inc.

(21) Appl. No.: 10/607,163

(22) Filed: Jun. 26, 2003

(51) Int. Cl. G06F 15/173; G06F 15/16

(52) U.S. Cl. 709/245; 709/238

(57) ABSTRACT

A parallel processor computer interconnect router comprises a multicasting module and a gathering module. The multicasting module is operable to receive a single incoming multicast packet comprising a destination identifier identifying a plurality of destination nodes, and to output multiple unicast packets, each of the multiple unicast packets comprising a destination header identifying a single destination node from among the plurality of destination nodes. The gathering module is operable to receive unicast reply packets from the plurality of destination nodes, and to output a combined multicast reply packet.

### FIELD OF THE INVENTION

The invention relates generally to multiprocessor computer systems, and more specifically to multiprocessor network multicasting and gathering.

### BACKGROUND OF THE INVENTION

Multiprocessor computer systems are desired for certain applications for their ability to process large amounts of data and for their ability to perform multiple tasks at the same time. When work can be efficiently divided up among the available processors in a multiprocessor system, performance dramatically exceeding the fastest uniprocessor machines is possible.

But, when more than one processor in a computer is working on the same task or operating on the same data as other processors, the activities of the processors must be coordinated to ensure that the work is appropriately divided and to ensure the integrity of data. This is accomplished in various multiprocessor systems by using shared memory space to communicate between processors, or by using message passing to send communication between processors. Both methods have limitations, in that shared memory systems allow only a single processor to access a memory location at a time and all processors must typically share the same system bus, whereas message passing machines are limited by the capacity of the processor network that carries messages and the latency in sending, routing, and receiving messages.

Further, when processors in a multiprocessor machine retain data in cache memory local to a processor, the cached data can become invalid when other processors change or request exclusive access to the data. A variety of protocols, including bus snooping and message passing, are therefore also used to ensure cache coherency or integrity in multiprocessor systems.

The demands this places upon the message passing system can have a significant impact on overall performance of the multiprocessor system, resulting in overall system performance that is limited by the processor network's capacity to route messages between processors. Fast and efficient routing of messages in a multiprocessor network environment is therefore desirable.

### SUMMARY OF THE INVENTION

In one embodiment of the invention, a parallel processor computer interconnect router is provided and comprises a multicasting module and a gathering module. The multicasting module is operable to receive a single incoming multicast packet comprising a destination identifier identifying a plurality of destination nodes, and to output multiple unicast packets, each of the multiple unicast packets comprising a destination header identifying a single destination node from among the plurality of destination nodes. The gathering module is operable to receive unicast reply packets from the plurality of destination nodes, and to output a combined multicast reply packet.

### BRIEF DESCRIPTION OF THE FIGURES

FIG. 1 shows an example parallel processor system connected via an interconnect network as may be used to practice some embodiments of the present invention.

FIG. 2 is a flowchart that illustrates a method of practicing one embodiment of the present invention.

### DETAILED DESCRIPTION

In the following detailed description of sample embodiments of the invention, reference is made to the accompanying drawings which form a part hereof, and in which is shown by way of illustration specific sample embodiments in which the invention may be practiced. These embodiments are described in sufficient detail to enable those skilled in the art to practice the invention, and it is to be understood that other embodiments may be utilized and that logical, mechanical, electrical, and other changes may be made without departing from the spirit or scope of the present invention. The following detailed description is, therefore, not to be taken in a limiting sense, and the scope of the invention is defined only by the appended claims.

The present invention provides in various embodiments a parallel processor computer interconnect router that features a multicasting module and a gathering module. The multicasting module is operable to receive a single incoming multicast packet comprising a destination identifier identifying a plurality of destination nodes, and to output multiple unicast packets, each of the multiple unicast packets comprising a destination header identifying a single destination node from among the plurality of destination nodes. The gathering module is operable to receive unicast reply packets from the plurality of destination nodes, and to output a combined multicast reply packet. These features facilitate consolidation of network messages such as cache invalidation messages that are sent to multiple nodes by reducing the number of network packets traveling over portions of a parallel processor interconnect network.

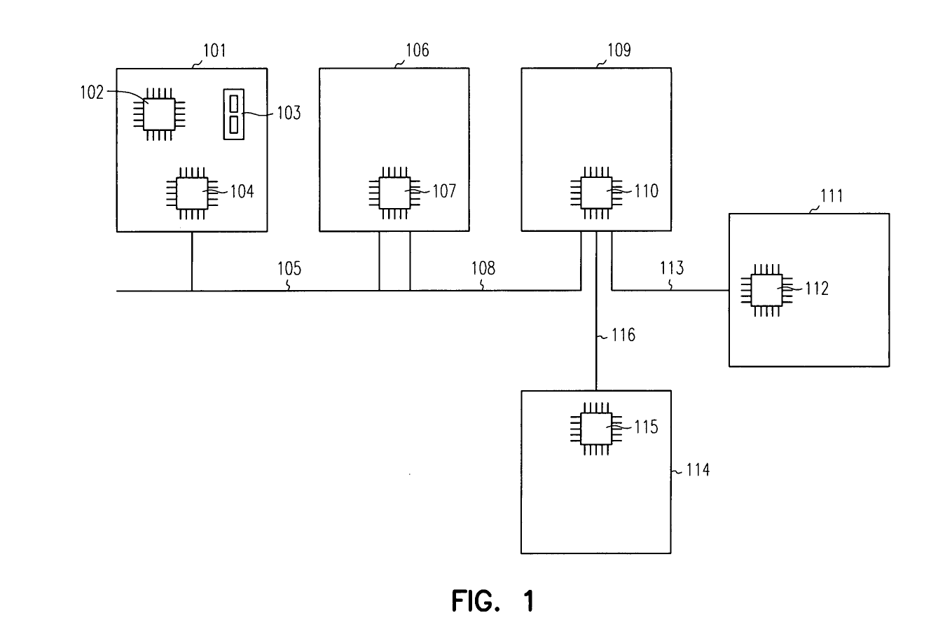

FIG. 1 shows an example parallel processor system connected via an interconnect network as may be used to practice some embodiments of the present invention. A network node 101 comprises a processor 102, cache memory 103, and a network router 104. The router connects the node 101 to network link 105, which provides communication between node 101 and node 106.

The node 106 also has a router 107, which facilitates communication with node 101 over network connection 105 and with node 109 over network connection 108. Similarly, the node 109 has a router 110 and is connected to node 111 having a router 112 via network connection 113 and is connected to node 114 having a router 115 via network connection 116. Nodes 111 and 114 can therefore communicate with node 101 via the various network connections and nodes with routers that link the nodes together.

In operation, node 101 has data that in this example must be communicated to both nodes 111 and 114. In a further embodiment of the invention, the data is a cache invalidate message that requires a reply acknowledgment from each of the receiving nodes. The node 101 creates a multicast packet identifying both node 111 and node 114 as destination nodes, and sends the packet via its router 104 and network connection 105 to node 106. Node 106 receives the multicast packet and routes the packet to node 109 via router 107 and network connection 108. This node in turn receives the multicast packet, and recognizes that the packet must be split to be routed to destination nodes 111 and 114. Router 110 therefore creates a unicast packet for node 111 and routes it to node 111 over network connection 113, and creates a unicast packet for node 114 and sends it via network connection 116.

If the receiving nodes must reply, such as is the case with a cache invalidate message in which each receiving node must reply with a cache invalidate acknowledge, the multicast packet sent from router 104 is identifies as a multicast with gather packet. As a result, the router 110 allocates a gather buffer to gather the unicast reply packets from nodes 111 and 114. If no gather buffer is available for allocation, the packet is not handled as a multicast with gather packet in router 110 but is handled as a simple multicast packet, such that the nodes 111 and 114 are instructed to reply directly to node 101 rather than to router 110. Upon receipt of all the anticipated unicast reply packets in a gather operation, the router 110 gathers the data from the various packets and creates a single reply packet that is sent via the interconnect network to node 101.

This method results in a reduction in the amount of network traffic that travels from node 101 via node 106 to node 109, both during transmission of the multicast packet and during transmission of the gathered unicast reply packet. In each case, only a single packet need be transferred between nodes 101 and 109, rather than the two packets that would need to be transmitted for each transaction in a traditional network interconnect system. In actual use, where a single cache invalidate packet or other packet may be sent to many destination processors, the reduction in network traffic over various parts of a processor interconnect network is likely to be more significant.

The present invention further has the benefit of reducing the network load of the source node, as it now handles only a single multicast packet rather than the multiple packets represented by a single multicast packet. When the source node is not the same node as the reply destination node that receives a gathered multicast reply packet, the reply destination node also realizes a reduction in network load by receiving only a single multicast gather reply packet instead of multiple unicast reply packets.

In a further embodiment of the invention, each of the nodes such as 101 may represent a cluster of processors local to a shared bus, such that the router 104 would serve to interconnect multiple processors to the network connection 105. In such networks of processor clusters, each router is responsible for facilitating network communication for each of the processors in the cluster, including formation of multicast packets.

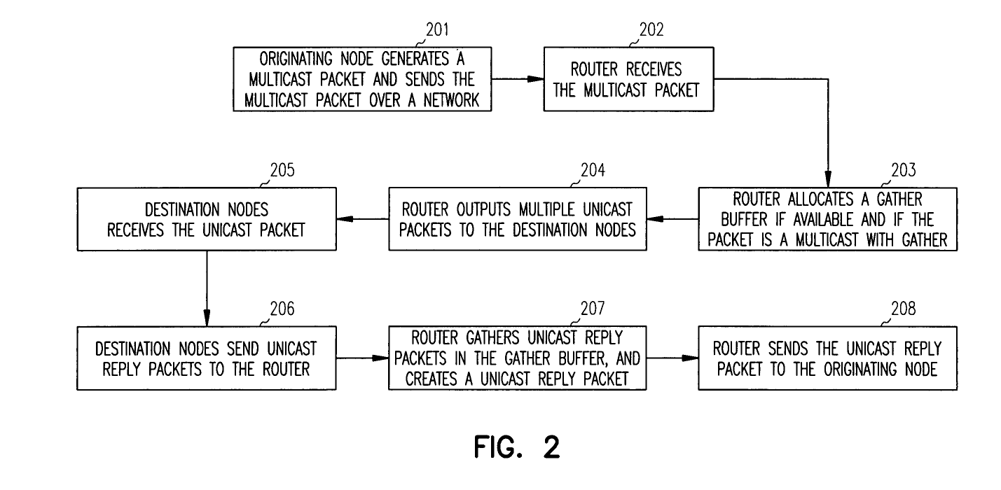

FIG. 2 is a flowchart that illustrates a method of practicing the present invention. At 201, an originating node creates a multicast packet with more than one intended destination node, and sends the multicast packet over a processor node interconnect network. At 202, a router receives the multicast packet. The multicast packet may travel through a number of routers and other network elements before reaching the router that finally processes the multicast packet. In one embodiment of the invention, the sending node determines the router at which the multicast packet will be processed using system configuration data before sending the multicast packet, and encodes the multicast packet such that the processing router or node is identified within the packet.

Processing the received multicast packet in the router starts at 203, where the router allocates a gather buffer if one is available in situations where a multicast with gather packet is received. The multicast with gather packet indicates that the router is to receive and gather replies to the multicast packet, and is to forward a packet containing the reply data to the originating node or other reply destination node designated in the multicast packet. In cases where the multicast packet is not a multicast with gather packet or where no gather buffer is available, no gather buffer is allocated and the packet is handled as a plain multicast packet.

The router outputs multiple unicast packets at 204, with each of the unicast packets routed to one of the intended destination nodes. The intended destination nodes receive the unicast packets from the router at 205, and if a reply is required send a unicast reply packet back to the router at 206. In situations where the reply packet is not a reply to a multicast with gather, the reply packet may be routed directly to the originating node or other designated reply destination node rather than to the router.

The router gathers the unicast reply packets from the intended destination nodes of the original multicast packet at 207, and stores the replies in the gather buffer allocated at 203. The router then creates a unicast reply packet representing the replies of the various intended destination nodes, and sends the unicast reply packet to the originating node or other reply destination node at 208.

The example method described in conjunction with FIG. 2 illustrates how the present invention can reduce network traffic in a processor interconnect network by using multicast packets and by converting reply packets into a unicast reply packet via a gather function. Application of the invention to cache invalidation or cache update signals sent over a processor interconnect network illustrates how the present invention can result in a substantial reduction in network traffic, considering that a single multicast packet is sent over a portion of the network rather than sending several unicast packets and several reply packets over the network portion. Further, a reduction in network load of the multicast packet originating node and in the reply packet destination node is realized. These are examples of how the present invention may be applied to achieve reduction in network traffic in certain applications, but many other applications for the present invention exist and are within the scope of the invention as claimed.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is intended that this invention be limited only by the claims, and the full scope of equivalents thereof.

1. A parallel processor computer interconnect router, the interconnect router comprising:
a multicasting module operable to receive a single incoming multicast packet comprising a destination identifier identifying a plurality of destination nodes, and to output multiple unicast packets, each of the multiple unicast packets comprising a destination header identifying a single destination node from among the plurality of destination nodes; and
a gathering module operable to receive unicast reply packets from the plurality of destination nodes, and to output a combined multicast reply packet.

2. The parallel processor computer interconnect router of claim 1, wherein the single incoming multicast packet comprises a cache invalidation message.

3. The parallel processor computer interconnect router of claim 2, wherein the unicast reply packets comprise cache invalidation acknowledge packets.

4. The parallel processor computer interconnect router of claim 1, wherein the output combined multicast reply packet is routed to a reply destination node designated by the single incoming multicast packet.

5. The parallel processor computer interconnect router of claim 1, wherein the output combined multicast reply packet is routed to a reply destination node that is a node other than the node sending the single incoming multicast packet.

6. The parallel processor computer interconnect router of claim 1, wherein the output combined multicast reply packet is routed to the node sending the single incoming multicast packet.

7. The parallel processor computer interconnect router of claim 1, wherein the router is associated with a local plurality of processors comprising a subset of processors in a parallel processor computer system, and creates multicast packets only for processors locally known to the router.

8. The parallel processor computer interconnect router of claim 1, wherein the gathering module comprises a gather buffer which is allocated to gather unicast reply packets if a gather buffer is available.

9. The parallel processor computer interconnect router of claim 8, wherein the gather buffer is allocated if available on receipt of incoming multicast packets that indicate a multicast with gather is desired.

10. The parallel processor computer interconnect router of claim 9, wherein incoming multicast packets that indicate a multicast with gather is desired are converted to a multicast without gather if a gather buffer cannot be allocated.

11. A method of routing packets via a router in a parallel processing computer interconnect network, comprising:
receiving in the router an incoming multicast packet comprising a destination identifier identifying a plurality of destination nodes;
outputting from the router multiple unicast packets, each of the multiple unicast packets comprising a destination header identifying a single destination node from among the plurality of destination nodes; and
receiving in the router unicast reply packets from the plurality of destination nodes, and;
outputting from the router a combined multicast reply packet.

12. The method of claim 11, wherein the single incoming multicast packet comprises a cache invalidation message.

13. The method of claim 11, wherein the unicast reply packets comprise cache invalidation acknowledge packets.

14. The method of claim 11, wherein the output combined multicast reply packet is routed to a node designated by the single incoming multicast packet.

15. The method of claim 11, wherein the output combined multicast reply packet is routed to a reply destination node that is a node other than the node sending the single incoming multicast packet.

16. The method of claim 11, wherein the output combined multicast reply packet is routed to the node sending the single incoming multicast packet.

17. The method of claim 11, wherein the router is associated with a plurality of locally known processors comprising a subset of all processors in a parallel processor computer system, and creates multicast packets only for processors locally known to the router.

18. The method of claim 11, further comprising allocating a gather buffer to gather unicast reply packets if a gather buffer is available.

19. The method of claim 18, wherein the gather buffer is allocated if available on receipt of incoming multicast packets that indicate a multicast with gather is desired.

20. The method of claim 19, further comprising converting incoming multicast packets that indicate a multicast with gather is desired to a multicast without gather if a gather buffer cannot be allocated.

21. An information handling system comprising multiple processors connected via an interconnect network and at least one router, the router comprising:
a multicasting module operable to receive a single incoming multicast packet comprising a destination identifier identifying a plurality of destination nodes, and to output multiple unicast packets, each of the multiple unicast packets comprising a destination header identifying a single destination node from among the plurality of destination nodes; and
a gathering module operable to receive unicast reply packets from the plurality of destination nodes, and to output a combined multicast reply packet.

22. The information handling system of claim 21, wherein the single incoming multicast packet comprises a cache invalidation message.

23. The information handling system of claim 21, wherein the unicast reply packets comprise cache invalidation acknowledge packets.

24. The information handling system of claim 21, wherein the output combined multicast reply packet is routed to a node designated by the single incoming multicast packet.

25. The information handling system of claim 21, wherein the output combined multicast reply packet is routed to a reply destination node that is a node other than the node sending the single incoming multicast packet.

26. The information handling system of claim 21, wherein the output combined multicast reply packet is routed to the node sending the single incoming multicast packet.

27. The information handling system of claim 21, wherein the router is associated with a locally known plurality of processors comprising a subset of all processors in a parallel processor computer system, and creates multicast packets only for processors locally known to the router.

28. The information handling system of claim 22, wherein the gathering module comprises a gather buffer which is allocated to gather unicast reply packets if a gather buffer is available.

29. The information handling system of claim 28, wherein the gather buffer is allocated if available on receipt of incoming multicast packets that indicate a multicast with gather is desired.

30. The information handling system of claim 29, wherein incoming multicast packets that indicate a multicast with gather is desired are converted to a multicast without gather if a gather buffer cannot be allocated.
